(19) United States
(12) Patent Application Publication
(10) Pub. No.: US 2018/0368625 A1
(43) Pub. Date: Dec. 27, 2018

(54) COOKWARE AND COOKWARE SET

(71) Applicant: REMY INC., Tokyo (JP)

(72) Inventors: Ritsu WADA, Tokyo (JP); Remi WADA, Tokyo (JP)

(21) Appl. No.: 16/062,029

(22) PCT Filed: May 18, 2016
(86) PCT No.: PCT/JP2016/064788

§ 371 Date: Jun. 13, 2018

(51) Int. Cl. A47J 43/28; A47J 45/06

(52) U.S. Cl. CPC A47J 43/287; A47J 45/06

(57) ABSTRACT

Cookware is provided that includes a body having a bottom and a sidewall; and a handle on the sidewall. The handle has a guide groove for supporting a rod-shaped grip of a cooking tool. The guide groove supports the grip so that the cooking tool passes through an upper side of an upper end of the sidewall. The handle extends obliquely upward from the sidewall. A width of the guide groove is reduced from a tip side of the handle toward a base side of the handle.

### BACKGROUND

### Technical Field

An object of the present invention is to provide a cookware having a body that has a bottom plate and a sidewall raised upward from an outer periphery of the bottom plate, and a cookware set having the cookware and a cooking tool.

### Related Art

In cooking by using a cookware such as a pan and a frying pan, and a cooking tool such as a turner and a ladle, a place on which the cooking tool is temporarily placed is required so as to prevent an adhered substance adhering to the cooking tool from being adhered to a cooking table or the like.

So as to meet such a need, a technology on providing a handle of the cookware with a groove has been proposed (for example, JP 2005-334583 A). According to such a cookware, a temporary place of the cooking tool is ensured by placing the cooking tool in the groove provided in the handle.

Incidentally, the cookware described above has a body that has a bottom plate and a sidewall raised upward from an outer periphery of the bottom plate. The body is brought into contact with a cooking heater such as a gas cooker, an electric cooker and an IH heater, and therefore a temperature of the body is increased to a significantly high level during cooking.

However, the cooking tool is brought into contact with the sidewall of the body in the cookware described above, and therefore a temperature of the cooking tool also has a possibility of being increased to a high level by heat transmitted from the sidewall of the body. If the temperature of the cooking tool is increased to a high level, such a problem occurs, in which a user cannot hold the cooking tool or the cooking tool is damaged.

Accordingly, the present invention has been made in order to solve the problems described above, and an object of the present invention is to provide a cookware capable of suppressing a temperature rise of a cooking tool while ensuring a temporary place of the cooking tool; and a cookware set.

### SUMMARY

As a first feature, a gist is a cookware, including a body that has a bottom plate and a sidewall raised upward from an outer periphery of the bottom plate; and a handle provided on an outer surface of a side surface of the sidewall and positioned outside the body, wherein the handle has a guide groove for supporting a rod-shaped grip of a cooking tool, on a top surface of the handle; the guide groove supports the grip in such a manner that the cooking tool passes through an upper side of an upper end of the sidewall, in a place in which the handle is provided on the outer surface; the handle has a shape extending obliquely upward from the outer surface of the sidewall; and a width of the guide groove is reduced from a tip side of the handle toward a base side of the handle.

As a second feature, a gist is the first feature, wherein a virtual line obtained by virtually extending a groove bottom of the guide groove to a side of the body passes through an upper side of an upper end of the sidewall, in a place in which the handle is provided on the outer surface, and the guide groove has a predetermined shape in corresponding to the grip in a top view of the cookware.

As a third feature, a gist is the first feature or the second feature, wherein the handle has a shape extending obliquely upward from the outer surface of the sidewall, and the handle further has a first portion in contact with the outer surface of the sidewall; and a second portion continuing to the first portion, the first portion has a first angle as an inclination angle relative to a plane parallel to the bottom plate, the second portion has a second angle smaller than the first angle as the inclination angle relative to the plane parallel to the bottom surface, the guide groove is provided on a top surface of the second portion, the virtual line obtained by virtually extending the groove bottom of the guide groove to the side of the body passes through the upper side of the upper end of the sidewall, in a place in which the handle is provided on the outer surface, and a width of the guide groove is reduced from a tip side of the second portion toward a base side of the second portion.

As a fourth feature, a gist is the third feature, wherein a length of the guide groove is equal to or more than a half of a length of the second portion in a direction in which the second portion is extended.

As a fifth feature, a gist is the third feature or the fourth feature, wherein a groove bottom of the guide groove in a boundary portion between the first portion and the second portion is positioned on an upper side above an upper end of the sidewall, in a place in which the handle is provided on the outer surface.

As a sixth feature, a gist is the first feature to the fifth feature, wherein the handle has a magnet in a portion in which the guide groove is provided.

As a seventh feature, a gist is the first feature to the sixth feature, wherein the handle has a holding part for holding an end part of the grip supported by the guide groove.

As an eighth feature, a gist is the seventh feature, wherein the holding part has an insertion port into which an end part of the grip is inserted in a state in which the grip is supported by the guide groove, and a regulation part positioned on an upper side of the end part of the grip inserted into the insertion port to regulate upward movement of the end part of the grip.

As a ninth feature, a gist is the seventh feature, wherein the holding part has a regulation part positioned on an upper side of a folded portion of an end part of the grip in a state in which the grip is supported by the guide groove to regulate upward movement of the folded portion.

As a tenth feature, a gist is a cookware set including: a cookware; and a cooking tool having a rod-shaped grip, wherein the cookware includes: a body that has a bottom plate and a sidewall raised upward from an outer periphery of the bottom plate; and a handle provided on an outer surface of a side surface of the sidewall and positioned outside the body; the handle has a guide groove for supporting the grip, on a top surface of the handle; the guide groove supports the grip in such a manner that the cooking tool passes through an upper side of an upper end of the sidewall, in a place in which the handle is provided on the outer surface; the handle has a shape extending obliquely upward from the outer surface of the sidewall; and a width of the guide groove is reduced from a tip side of the handle toward a base side of the handle.

As an eleventh feature, a gist is the tenth feature, wherein a width of the grip is reduced from a tip side of the grip toward a base side of the grip.

As a twelfth feature, a gist is the eleventh feature, wherein the guide groove has a predetermined shape in corresponding to the grip in a top view of the cookware.

As a thirteenth feature, a gist is any one of the tenth feature to the twelfth feature, wherein the handle has a first portion in contact with the outer surface of the sidewall; and a second portion continuing to the first portion, the first portion has a first angle as an inclination angle relative to a plane parallel to the bottom plate, the second portion has a second angle smaller than the first angle as the inclination angle relative to the plane parallel to the bottom surface, the guide groove is provided on a top surface of the second portion, a virtual line obtained by virtually extending the groove bottom of the guide groove to a side of the body passes through the upper side of the upper end of the sidewall, in a place in which the handle is provided on the outer surface, and a width of the guide groove is reduced from a tip side of the second portion toward a base side of the second portion.

As a fourteenth feature, a gist is any one of the tenth feature to the thirteenth feature, wherein either the handle or the grip has a magnet and the other of the handle or the grip is formed of a magnetic body.

As a fifteenth feature, a gist is any one of the tenth feature to the thirteenth feature, wherein the handle has a first magnet, the grip has a second magnet, and the first magnet and the second magnet are provided in a position in which both are faced each other.

### Advantageous Effects of Invention

The present invention can provide a cookware capable of suppressing a temperature rise of a cooking tool while ensuring a temporary place of the cooking tool and a cookware set.

### BRIEF DESCRIPTION OF DRAWINGS

FIG. 1 is a diagram showing a cookware set 10 according to First Embodiment.

FIG. 2 is a diagram showing a cooking tool 200 according to First Embodiment.

FIG. 3 is a diagram showing a cookware 100 according to First Embodiment.

FIG. 4 is a diagram showing a cookware 100 according to First Embodiment.

FIG. 5 is a diagram showing a handle 120 according to First Embodiment.

FIG. 6 is a diagram showing a cookware 100 according to Modified Example 1.

FIG. 7 is a diagram showing a cooking tool 200 according to Modified Example 1.

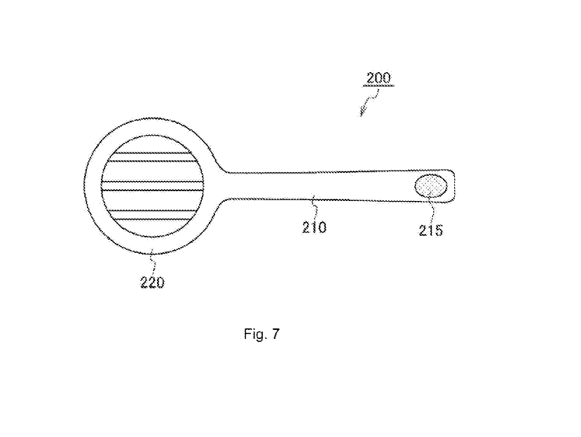

FIG. 8 is a diagram showing a cooking tool 200 according to Modified Example 2.

FIG. 9 is a diagram showing a handle 120 according to Modified Example 2.

FIG. 10 is a diagram showing a holding part 300 according to Modified Example 2.

FIGS. 11A-11D are diagrams showing a holding part 300 according to Modified Example 2.

FIG. 12 is a diagram showing a cooking tool 200 according to Modified Example 3.

FIG. 13 is a diagram showing a handle 120 according to Modified Example 3.

FIG. 14 is a diagram showing a holding part 300 according to Modified Example 3.

FIGS. 15A-15E are diagrams showing a holding part 300 according to Modified Example 3.

FIG. 16 is a diagram showing a cookware 100 according to Modified Example 4.

FIG. 17 is a diagram showing a lid 400 according to Modified Example 4.

FIG. 18 is a sectional view of a body.

FIGS. 19A-19E are diagrams showing a structure of a handle.

### DETAILED DESCRIPTION

Hereinafter, embodiments will be described. In addition, the same or similar portions in the description of a figure below are provided with the same or similar signs. However, it should be noted that the figure is schematic and a ratio of each dimension is different from an actual dimension.

Accordingly, a specific dimension or the like should be judged with reference to the description below. Moreover, portions different in a dimensional relationship or a ratio with each other are also obviously included between the figures.

### Summary of Embodiment

A cookware according to an embodiment includes: a body that has a bottom plate and a sidewall raised upward from an outer periphery of the bottom plate; and a handle provided on an outer surface of a side surface of the sidewall and positioned outside the body. The handle has a guide groove for supporting a rod-shaped grip of a cooking tool, on a top surface of the handle. The guide groove supports the grip in such a manner that the cooking tool passes through an upper side of an upper end of the sidewall, in a place in which the handle is provided on the outer surface, and the handle has a shape extending obliquely upward from the outer surface of the sidewall, and a width of the guide groove is reduced from a tip side of the handle toward a base side of the handle.

In the embodiment, the guide groove supports the grip in the place in which the handle is provided on the outer surface in such a manner that the cooking tool passes through the upper side of the upper end of the sidewall. Accordingly, a temperature rise of the cooking tool can be suppressed while ensuring a temporary place of the cooking tool.

In the embodiment, the width of the guide groove is reduced from the tip side of the handle toward the base side of the handle. Accordingly, the width of the handle is large on the tip side of the handle, and therefore the grip of the cooking tool is easily arranged on the guide groove, and the width of the guide groove is narrow on the base side of the handle, and thus the grip of the cooking tool can be stably supported.

### First Embodiment

### Cookware Set

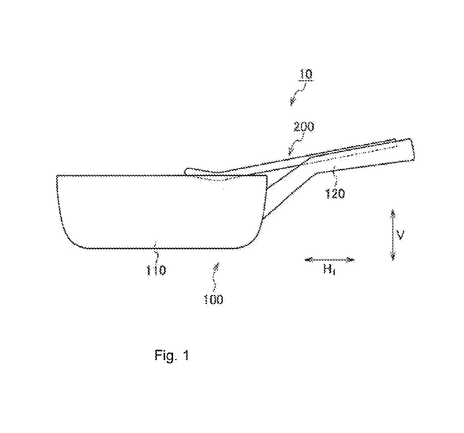

In the following, a cookware set according to First Embodiment will be described. FIG. 1 is a diagram showing a cookware set 10 according to First Embodiment. FIG. 1 shows a side view of the cookware set 10.

As shown in FIG. 1, the cookware set 10 has a cookware 100 and a cooking tool 200. The cookware 100 is a pan or a frying pan, for example. The cookware 100 has a body 110 and a handle 120. The cooking tool 200 is a turner, a ladle, a spatula or a scoop, for example.

In the following, the cookware 100 will be described in a space defined by a horizontal direction H₁, a horizontal direction H₂ and a vertical direction V. The horizontal direction H₁ and the horizontal direction H₂ are directions which define a horizontal plane. The horizontal direction H₁ is a direction along which the handle 120 is extended. The horizontal direction H₂ is a direction orthogonal to the horizontal direction H₁. The vertical direction V is a direction orthogonal to the horizontal direction H₁ and the horizontal direction H₂.

### Cooking Tool

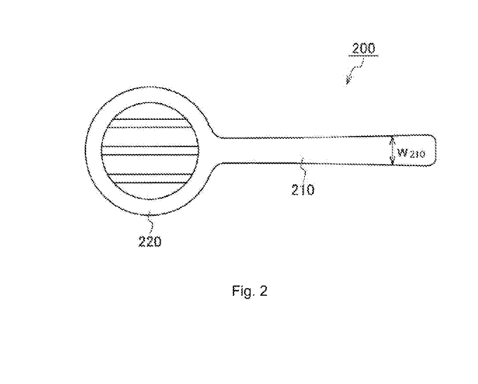

In the following, a cooking tool according to First Embodiment will be described. FIG. 2 is a diagram showing the cooking tool 200 according to First Embodiment. FIG. 2 shows a top view of the cooking tool 200. As shown in FIG. 2, the cooking tool 200 has a grip 210 and a functional portion 220.

The grip 210 has a rod-like shape. The grip 210 has a width W₂₁₀. The grip 210 may have a columnar shape or a flat plate shape. The grip 210 is formed of a thermally conductive member such as stainless steel. However, the grip 210 may be formed of a plastic.

Here, the width W₂₁₀ of the grip 210 preferably is reduced from a tip side of the grip 210 toward a base side of the grip 210. In other words, a width W_{210T} of the grip 210 on the tip side of the grip 210 is larger than a width W_{210B} of the grip 210 on the base side of the grip 210.

The functional portion 220 is a portion for cooking ingredients in the cookware 100. FIG. 2 illustrates a functional portion of the turner as the functional portion 220. The functional portion 220 is formed of a thermally conductive member such as stainless steel. However, the cooking tool 200 may be formed of a plastic.

### Cookware

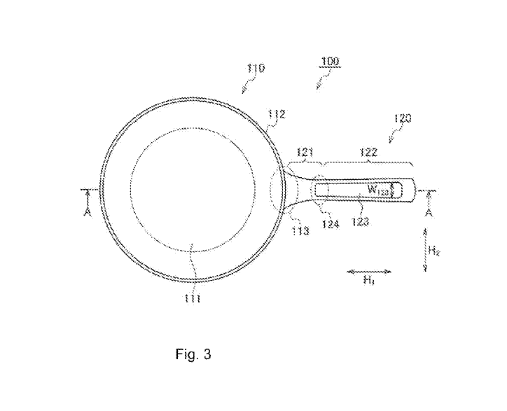

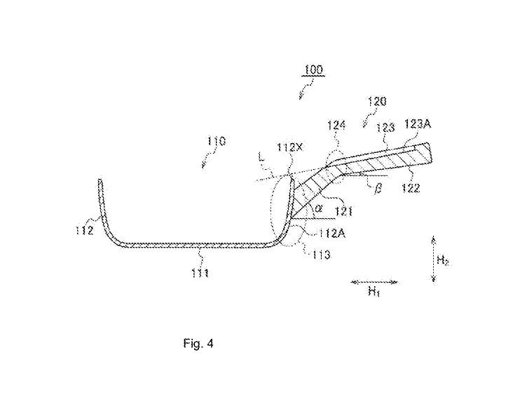

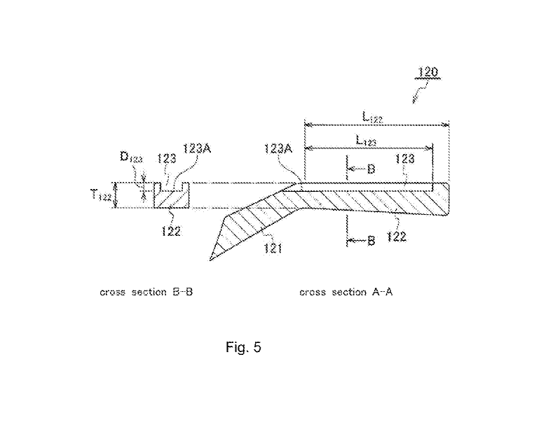

In the following, the cookware according to First Embodiment will be described. FIGS. 3 to 5 each are a diagram showing a cookware 100 according to First Embodiment. FIG. 3 shows a top view of the cookware 100. FIG. 4 shows a sectional view A-A of the cookware 100 shown in FIG. 3. FIG. 5 shows an enlarged sectional view of a handle 120. As described above, the cookware 100 has the body 110 and the handle 120.

As shown in FIGS. 3 to 5, the body 110 has a bottom plate 111 and a sidewall 112. The body 110 is formed of iron or stainless steel, for example.

The bottom plate 111 has a shape spread along a horizontal plane defined by a horizontal direction H₁ and a horizontal direction H₂. The bottom plate 111 may have a circular shape or a rectangular shape.

The sidewall 112 has a shape raised upward from an outer periphery of the bottom plate 111. The sidewall 112 is continued along the outer periphery of the bottom plate 111.

The handle 120 is provided on an outer surface 112A of a side surface of the sidewall 112 and positioned outside the body 110. The handle 120 has a shape extending along the horizontal direction H₁.

In First Embodiment, the handle 120 has a shape extending obliquely upward from the outer surface 112A of the sidewall 112. The handle 120 has: a first portion 121 in contact with the outer surface 112A of the sidewall 112; a second portion 122 continued to the first portion 121; and a guide groove 123 for supporting the grip 210 of the cooking tool 200. The handle 120 is formed of iron or stainless steel, for example. The handle 120 may be connected to the outer surface 112A of the sidewall 112, or the handle 120 may be detachably provided on the outer surface 112A of the sidewall 112.

The first portion 121 has a first angle α as an inclination angle relative to a plane (namely, a horizontal plane) parallel to the bottom plate 111, as shown in FIG. 4. The first angle α may be an angle formed by a lower surface of the first portion 121 and the horizontal plane or an angle formed by a center line of the first portion 121 and the horizontal plane. A top surface of the first portion 121 preferably reaches an upper side above an upper end 112X of the sidewall 112 in a place 113 in which the handle 120 is provided on the outer surface 112A of the sidewall 112 (body 110).

The second portion 122 has a second angle β as the inclination angle relative to the plane (namely, the horizontal plane) parallel to the bottom plate 111, as shown in FIG. 4. The second angle β may be an angle formed by a lower surface of the second portion 122 and the horizontal plane or an angle formed by a center line of the second portion 122 and the horizontal plane. The second angle β is smaller than the first angle α.

The guide groove 123 is provided on a top surface of the handle 120. The guide groove 123 has a width W₁₂₃ as shown in FIG. 3. The width W₁₂₃ of the guide groove 123 is preferably larger than the width W₂₁₀ of the grip 210.

In First Embodiment, the guide groove 123 is preferably provided on a top surface of the second portion 122. The guide groove 123 preferably is opened on a side of the body 110 in a boundary portion 124 between the first portion 121 and the second portion 122. The guide groove 123 may be continued to the first portion 121. However, even in such a case, the grip 210 of the cooking tool 200 is preferably not brought into contact with the first portion 121 in a state in which the grip 210 is supported by the guide groove 123.

In First Embodiment, the width W₁₂₃ of the guide groove 123 is reduced from a tip side of the handle 120 toward a base side of the handle 120. Here, the width W₁₂₃ of the guide groove 123 is reduced from a tip side of the second portion 122 toward a base side of the second portion 122. In other words, a width W_{123T} of the guide groove 123 on the tip side of the second portion 122 is larger than a width W_{123B} of the guide groove 123 on the base side of the second portion 122.

The guide groove 123 preferably has a predetermined shape in corresponding to the grip 210 of the cooking tool 200 in a top view of the cookware 100. More specifically, the width W₁₂₃ of the guide groove 123 is preferably determined in such a manner that, if the grip 210 of the cooking tool 200 is slid from the tip side of the second portion 122 toward the base side of the second portion 122, the functional portion 220 of the cooking tool 200 is stopped on the body 110. That is, the guide groove 123 has a function of positioning the grip 210 of the cooking tool 200, and simultaneously has a function of supporting the grip 210 of the cooking tool 200 in such a manner that the functional portion 220 of the cooking tool 200 is not displaced in the horizontal direction H₂.

In addition, a term “predetermined shape” means a shape in which at least the width W_{123B} of the guide groove 123 on the base side of the second portion 122 is the same with the width W₂₁₀ on the way of the grip 210 of the cooking tool 200 in such a manner that the functional portion 220 of the cooking tool 200 is stopped on the body 110. Moreover, the term “the predetermined shape” means a shape which may include some error as long as the shape of the guide groove 123 and the shape of the grip 210 of the cooking tool 200 are similar to each other at a degree of suppressing the functional portion 220 of the cooking tool 200 from being displaced in the horizontal direction H₂.

Here, the guide groove 123 supports the grip 210 in such a manner that the cooking tool 200 passes through the upper side of the upper end 112X of the sidewall 112 in the place 113 in which the handle 120 is provided on the outer surface 112A. More specifically, in First Embodiment, as shown in FIG. 4, a virtual line L obtained by virtually extending a groove bottom 123A of the guide groove 123 to the side of the body 110 preferably passes through the upper side of the upper end 112X of the sidewall 112 in the place 113 in which the handle 120 is provided on the outer surface 112A of the sidewall 112 (body 110).

The groove bottom 123A of the guide groove 123 may have a flat plane. The groove bottom 123A of the guide groove 123 may have a convex shape projected upward in a cross section along the horizontal direction H₁ and the vertical direction V. The groove bottom 123A of the guide groove 123 may have a concave shape recessed downward in the cross section along the horizontal direction H₂ and the vertical direction V.

Here, it should be noted that, when the groove bottom 123A of the guide groove 123 has the convex shape projected upward in the cross section along the horizontal direction H₁ and the vertical direction V, the virtual line L described above is a tangent line between the groove bottom 123A and the grip 210.

In First Embodiment, as shown in FIG. 5, a length L₁₂₃ of the guide groove 123 is preferably equal to or more than a half of a length L₁₂₂ of the second portion 122 in a direction in which the second portion 122 is extended. Thus, the grip 210 of the cooking tool 200 is hard to be displaced from the guide groove 123, and the grip 210 of the cooking tool 200 is easily stably supported by the guide groove 123. The groove bottom 123A of the guide groove 123 is preferably positioned on the upper side of the upper end 112X of the sidewall 112 in the place 113 in which the handle 120 is provided on the outer surface 112A of the sidewall 112 (body 110). Thus, the grip 210 of the cooking tool 200 is hard to be brought into contact with the upper end 112X of the sidewall 112.

In addition, as shown in FIG. 5, the second portion 122 has a thickness T₁₂₂ and the guide groove 123 has a depth D₁₂₃. The depth D₁₂₃ of the guide groove 123 is preferably equal to or less than a half of the thickness T₁₂₂ of the second portion 122. Thus, strength of the second portion 122 is secured. However, the depth D₁₂₃ of the guide groove 123 preferably has a depth at a degree of easily supporting the grip 210 of the cooking tool 200.

### Operation and Effect

In First Embodiment, the guide groove 123 for supporting the grip 210 of the cooking tool 200 supports the grip 210 in such a manner that the cooking tool 200 passes through the upper side of the upper end 112X of the sidewall 112, in the place in which the handle 120 is provided on the outer surface 112A. Specifically, in First Embodiment, the guide groove 123 is provided on the top surface of the second portion 122 of the handle 120, and the virtual line L obtained by virtually extending the groove bottom 123A of the guide groove 123 to the side of the body 110 passes through the upper side of the upper end 112X of the sidewall 112 in the place 113 in which the handle 120 is provided on the outer surface 112A of the sidewall 112 (body 110). Accordingly, the temperature rise of the cooking tool 200 can be suppressed while ensuring a temporary place of the cooking tool 200.

In First Embodiment, the width of the guide groove 123 is reduced from the tip side of the handle 120 toward the base side of the handle 120. Specifically, in First Embodiment, the width of the guide groove 123 is reduced from the tip side of the second portion 122 toward the base side of the second portion 122. Accordingly, the width of the guide groove 123 on the tip side of the second portion 122 is relatively large, and therefore the grip 210 of the cooking tool 200 is easily arranged on the guide groove 123, and also the width of the guide groove 123 on the base side of the second portion 122 is relatively small, and therefore the grip 210 of the cooking tool 200 can be stably supported.

In First Embodiment, the guide groove 123 preferably has the predetermined shape in corresponding to the grip 210 of the cooking tool 200 in the top view of the cookware 100. According to such a configuration, the guide groove 123 can fulfill the function of positioning the grip 210 of the cooking tool 200, and simultaneously can support the grip 210 of the cooking tool 200 in such a manner that the functional portion 220 of the cooking tool 200 is not displaced.

### MODIFIED EXAMPLE 1

In the following, Modified Example 1 of First Embodiment will be described. Differences from First Embodiment will be mainly described below.

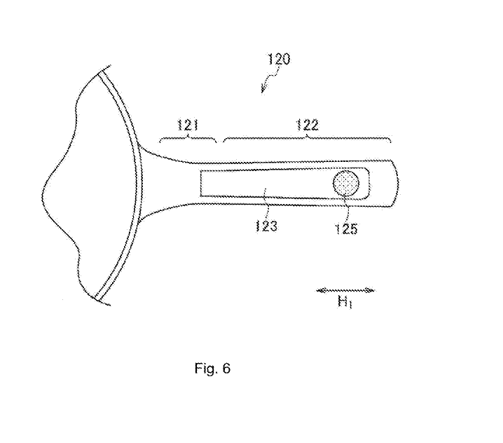

Specifically, in Modified Example 1, as shown in FIG. 6, a handle 120 has a magnet 125 in a portion in which a guide groove 123 is provided. The magnet 125 is preferably provided in a place separated from a body 110 and from a center of the handle 120 in a direction in which the handle 120 is extended. The magnet 125 may be exposed on a front surface of the handle 120, or may be embedded into the handle 120. In such a case, a grip 210 of a cooking tool 200 is formed of a magnetic body such as stainless steel. However, a whole of the grip 210 of the cooking tool 200 is not necessarily formed of the magnetic body, and a portion of the grip 210 of the cooking tool 200 and facing the magnet 125 only needs to be formed of the magnetic body.

Alternatively, in Modified Example 1, a grip 210 of a cooking tool 200 preferably has a magnet 215. The magnet 215 is preferably provided in a position separated from a functional portion 220 and from a center of a grip 210 in a direction in which the grip 210 is extended. The magnet 215 may be exposed on a front surface of the grip 210, or may be embedded into the grip 210. In such a case, the handle 120 is formed of a magnetic body such as iron and stainless steel. However, a whole of a handle 120 is not necessarily formed of the magnetic body, and a portion of the handle 120 and facing the magnet 215 only needs to be formed of the magnetic body.

Alternatively, in Modified Example 1, a handle 120 may have a magnet 125 and a grip 210 may have a magnet 215. In such a case, the magnet 125 and the magnet 215 are preferably provided in a place in which the magnet 125 and the magnet 215 are faced each other in a state in which the grip 210 is supported on a guide groove 123. Polarity of the magnet 125 and polarity of the magnet 215 are obviously opposite. However, when both the handle 120 and the grip 210 are formed of a magnetic body, it is unnecessary that the magnet 125 and the magnet 215 are provided in a position in which both are faced each other.

### Operation and Effect

In Modified Example 1, at least either the magnet 125 or the magnet 215 is provided. Accordingly, the grip 210 of the cooking tool 200 is hard to be displaced from the guide groove 123, and the grip 210 of the cooking tool 200 is stably supported by the guide groove 123.

### MODIFIED EXAMPLE 2

In the following, Modified Example 2 of First Embodiment will be described. Differences from First Embodiment will be mainly described below.

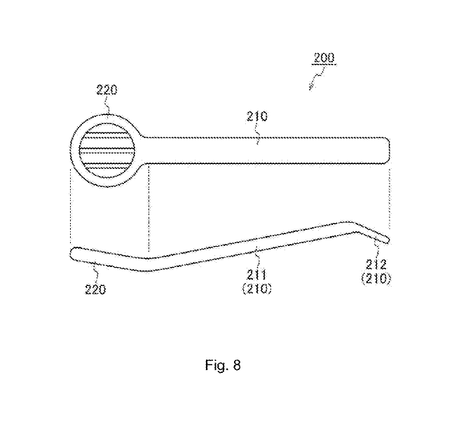

Specifically, in Modified Example 2, as shown in FIG. 8, a grip 210 of a cooking tool 200 has an end part 212 positioned on a side opposite to a functional portion 220. The end part 212 may be bent relative to a body portion of the grip 210 without being folded.

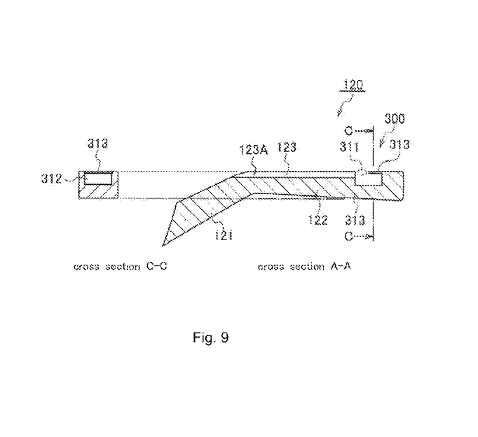

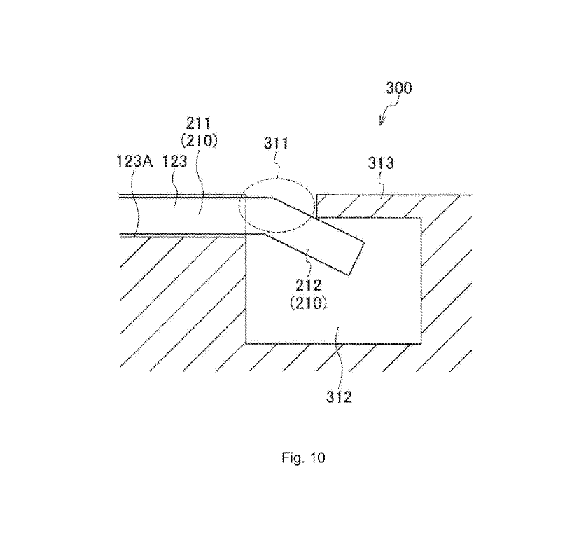

In such a case, as shown in FIGS. 9 and 10, a handle 120 of a cookware 100 has a holding part 300 for holding the end part 212 of the grip 210 supported by a guide groove 123. FIG. 9 shows an enlarged sectional view of the handle 120. FIG. 10 shows an enlarged sectional view of the holding part 300.

More specifically, the holding part 300 has an insertion port 311, a concave part 312 and a regulation part 313. However, it should be noted that the concave part 312 is not an essential configuration.

The insertion port 311 is an opening into which the end part 212 of the grip 210 is inserted in a state in which the grip 210 is supported by the guide groove 123. Accordingly, a width of the insertion port 311 is larger than a width W₂₁₀ of the grip 210. The concave part 312 houses the end part 212 in a state in which the end part 212 of the grip 210 is inserted into the insertion port 311. The regulation part 313 is positioned on an upper side of the end part 212 of the grip 210 inserted into the insertion port 311 to regulate upward movement of the end part 212 of the grip 210. The regulation part 313 is positioned on a side separated from a body 110 and from the insertion port 311. The regulation part 313 is a plate-like member for closing part of an opening of the concave part 312, for example. A width of the regulation part 313 in a cross section C-C shown in FIG. 9 may be larger than the width W₂₁₀ of the grip 210, or may be smaller than the width W₂₁₀ of the grip 210.

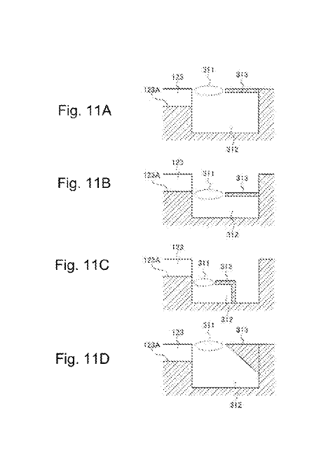

Here, as shown in FIG. 11, various variations are considered as a shape and a position of the regulation part 313. As shown in FIG. 11A, the regulation part 313 may have a plate-like shape, and may be provided at an upper end of a sidewall forming a concave part 312 and positioned on a side separated from a body 110. Alternatively, as shown in FIG. 11B, the regulation part 313 may have a plate-like shape, and may be provided at a center of the sidewall forming the concave part 312 and positioned on the side separated from the body 110. Alternatively, as shown in FIG. 11C, the regulation part 313 may have an L-shape, and may be provided on a bottom surface of the concave part 312. Alternatively, as shown in FIG. 11D, the regulation part 313 may have a triangular cross section, and may be provided in an upper end of the sidewall forming the concave part 312 and positioned on the side separated from the body 110.

Further, the regulation part 313 may be formed of the same material (for example, stainless steel or a plastic) as the material of the grip 210, or may be formed of an elastic member such as rubber.

In Modified Example 2, the end part 212 of the grip 210 supported by the guide groove 123 is held by the holding part 300. Accordingly, a length L₁₂₃ of the guide groove 123 may be equal to or less than a half of a length L₁₂₂ of a second portion 122. However, the length L₁₂₃ of the guide groove 123 may be obviously equal to or more than the half of the length L₁₂₂ of the second portion 122.

### Operation and Effect

In Modified Example 2, the handle 120 of the cookware 100 has the holding part 300 for holding the end part 212 of the grip 210 supported by the guide groove 123. When the end part 212 of the grip 210 is not folded, the grip 210 of the cooking tool 200 is hard to be displaced from the guide groove 123, and the grip 210 of the cooking tool 200 is easily stably supported by the guide groove 123.

### MODIFIED EXAMPLE 3

In the following, Modified Example 3 of First Embodiment will be described. Differences from First Embodiment will be mainly described below.

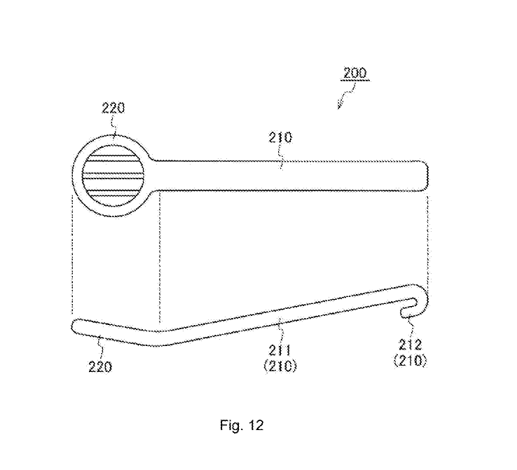

Specifically, in Modified Example 3, as shown in FIG. 12, a grip 210 of a cooking tool 200 has an end part 212 positioned on a side opposite to a functional portion 220. The end part 212 has a folded portion folded at least at 90 degrees or more.

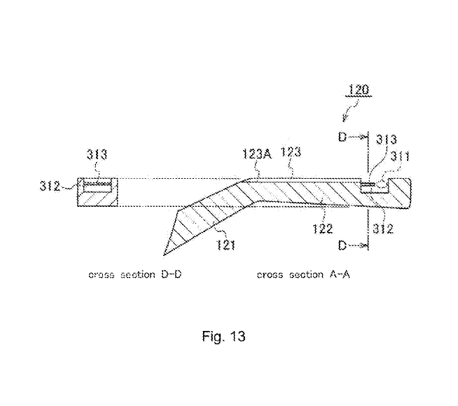

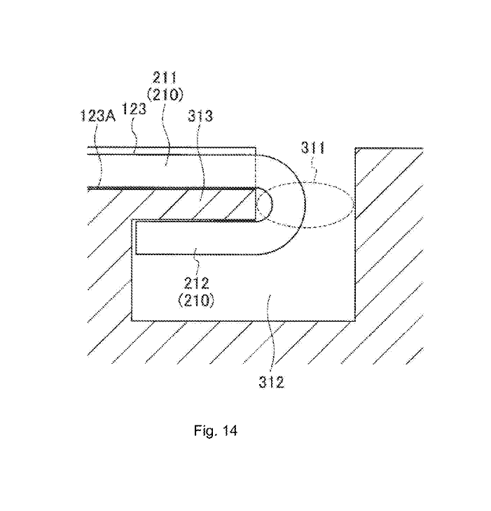

In such a case, as shown in FIGS. 13 and 14, a handle 120 of a cookware 100 has a holding part 300 for holding the end part 212 of the grip 210 supported by a guide groove 123. FIG. 13 shows an enlarged sectional view of the handle 120. FIG. 14 shows an enlarged sectional view of the holding part 300.

More specifically, the holding part 300 has an insertion port 311, a concave part 312 and a regulation part 313. However, it should be noted that the concave part 312 is not an essential configuration.

The insertion port 311 is an opening into which the folded portion of the end part 212 of the grip 210 is inserted in a state in which the grip 210 is supported by the guide groove 123.

Accordingly, a width of the insertion port 311 is larger than a width W₂₁₀ of the grip 210. The concave part 312 houses the end part 212 in a state in which the folded portion of the end part 212 of the grip 210 is inserted into the insertion port 311. The regulation part 313 is positioned on an upper side of the folded portion of the end part 212 of the grip 210 inserted into the regulation part 313 to regulate upward movement of the folded portion of the end part 212 of the grip 210. The regulation part 313 is positioned on a side closer to a body 110 from the insertion port 311. The regulation part 313 is a plate-like member for closing part of an opening of the concave part 312, for example. A width of the regulation part 313 in a cross section D-D shown in FIG. 13 may be larger than the width W₂₁₀ of the grip 210, or may be smaller than the width W₂₁₀ of the grip 210.

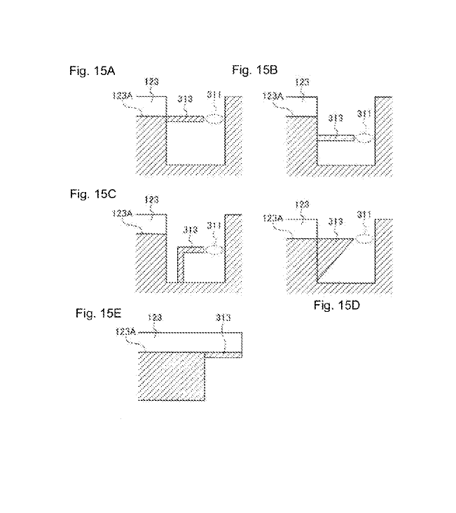

Here, as shown in FIG. 15, various variations are considered as a shape and a position of the regulation part 313. As shown in FIG. 15A, the regulation part 313 may have a plate-like shape, and may be provided in an upper end of a sidewall forming the concave part 312 and positioned on a side closer to a body 110. Alternatively, as shown in FIG. 15B, the regulation part 313 may have a plate-like shape, and may be provided in a center of the sidewall forming the concave part 312 and positioned on the side closer to the body 110. Alternatively, as shown in FIG. 15C, the regulation part 313 may have an L-shape, and may be provided on a bottom surface of the concave part 312. Alternatively, as shown in FIG. 15D, the regulation part 313 may have a triangular cross section, and may be provided in the upper end of the sidewall forming the concave part 312 and positioned on the side closer to the body 110. Alternatively, as shown in FIG. 15E, the regulation part 313 may have a plate-like shape, and may be provided in an upper end of the handle 120. It should be noted that the insertion port 311 and the concave part 312 are unnecessary in the example shown in FIG. 15E.

Further, the regulation part 313 may be formed of the same material (for example, stainless steel or a plastic) as the material of the grip 210, or may be formed of an elastic member such as rubber.

In Modified Example 3, the end part 212 of the grip 210 supported by the guide groove 123 is held by the holding part 300. Accordingly, a length L₁₂₃ of the guide groove 123 may be equal to or less than a half of a length L₁₂₂ of a second portion 122. However, the length L₁₂₃ of the guide groove 123 may be obviously equal to or more than the length L₁₂₂ of the second portion 122.

### Operation and Effect

In Modified Example 3, the handle 120 of the cookware 100 has the holding part 300 for holding the end part 212 of the grip 210 supported by the guide groove 123. When the end part 212 of the grip 210 is folded, the grip 210 of the cooking tool 200 is hard to be displaced from the guide groove 123, and the grip 210 of the cooking tool 200 is easily stably supported by the guide groove 123.

### MODIFIED EXAMPLE 4

In the following, Modified Example 4 of First Embodiment will be described. Differences from First Embodiment will be mainly described below.

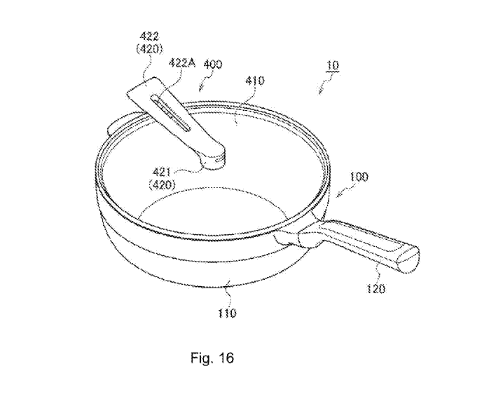

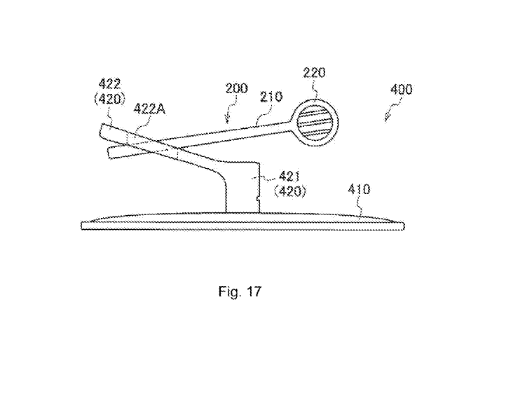

Specifically, in Modified Example 4, as shown in FIG. 16, a cookware 100 has a lid 400 for covering an opening of a body 110. As shown in FIGS. 16 and 17, the lid 400 has a lid body 410 and a lid handle 420. It should be noted that the lid 400 forms part of a cookware set 10.

The lid body 410 is a member for covering an opening of the body 110 of the cookware 100. The lid body 410 is formed of glass, for example, and is placed on an upper end of a sidewall 112 of the body 110.

The lid handle 420 has: a columnar portion 421 raised from the lid body 410; and a flat plate portion 422 extending from an upper end of the columnar portion 421 in a direction substantially parallel to the lid body 410. For example, when the lid body 410 has a disc shape, the columnar portion 421 is positioned in a center of the lid body 410, and the flat plate portion 422 has a shape extending along a radial direction from the columnar portion 421.

Here, the flat plate portion 422 has a slit 422A. The slit 422A is a vertically long opening extending along a direction (for example, a radial direction) in which the flat plate portion 422 is extended. As shown in FIG. 17, the grip 210 of the cooking tool 200 described above is inserted into the slit 422A. Accordingly, the slit 422A has a width at a degree capable of inserting the grip 210 thereinto. For example, when the grip 210 has a flat plate shape, a width of the slit 422A is preferably smaller than a width of the grip 210 and larger than a thickness of the grip 210.

### Operation and Effect

In Modified Example 4, the lid 400 has the lid handle 420 having the slit 422A into which the grip 210 of the cooking tool 200 is inserted. Accordingly, for example, a temporary place of the cooking tool 200 can be ensured in a state in which the lid 400 is placed on the cookware 100 (for example, in a state in which stew cooking, residual heat cooking or the like is performed).

### OTHER EXAMPLES

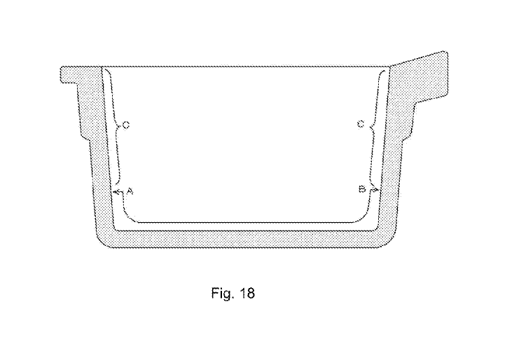

FIG. 18 is a diagram showing one example of a sectional view of a body of a cookware, which is the present invention. An inner side of the body from a position shown by A to a position shown by B in the figure is processed into a state in which a surface is roughened (for example, about 20 micrometers to about 150 micrometers in surface roughness Ra), and a region shown by C is processed into a state in which the surface is smooth (for example, about 20 micrometers or less in surface roughness Ra). Thus, oil is seasoned with an inner surface, and simultaneously a material to be cooked is supported in a dotted or linear form to produce an effect according to which the inner surface is hard to be abraded.

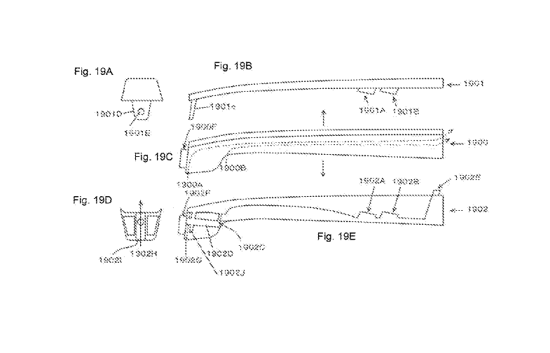

FIG. 19 is a diagram showing a structure of a handle of a cookware, which is the present invention. A portion shown by FIG. 19C in the figure is an outline drawing of a body portion (a dotted portion is a line showing a concept of circulation of air thereinside) of the handle. A portion shown by FIG. 19B in the figure shows an upper side portion of a handle body. A portion shown by FIG. 19E in the figure shows a lower side portion of the handle body (conceptual sectional view). That is, the handle body shown by FIG. 19C is completed by combining the portion FIG. 19B and the portion FIG. 19E.

In the upper side portion shown by FIG. 19B, a first cylindrical magnet container 1901A and a second cylindrical magnet container 1901B are arranged. With regard to two magnets stored herein, external air is configured to be introduced by first circulation 1900A of air in the portion shown by FIG. 19C in the figure and second circulation 1900B of air therein, and the magnets are configured to be cooled. Moreover, the container is configured to be sealed with a gap from the magnet itself, and receive a heat-insulation effect by an air layer. In addition, an amount of circulating air does not have to be so large, and an outlet portion of air is sufficient at a degree of the gap inevitably formed in a portion formed by combining the upper side and the lower side.

As the first circulation of air, air is introduced by a groove 1902G configured on the lower side. The groove 1902G is expressed as a groove 1902I in a front view FIG. 19D on the lower side. As the first circulation 1902H of air, air flows from the lower side toward the upper side.

As the second circulation of air, air is introduced from a hole 1902C provided in part of a threaded hole 1902D on the lower side. On the lower side, a first stopper part 1902A and a second stopper part 1902B for preventing a lid of the magnet container on the upper side from opening are arranged in addition thereto.

In an upper front, an insertion plate 1901C inserted into an insertion groove 1902J arranged in a lower front for fixing both is provided. The handle is configured in such a manner that the insertion plate is provided with a hole 1901E through which a screw can be passed, in a center thereof, and the screw is passed through 1902D to a threaded hole provided on the body, and the screw is screwed thereinto and both are fixed.

The handle is configured in such a manner that a projection 1902E on the lower side is fitted into a hole (not shown) of 1901 on the upper side and both are temporarily fixed.

### Other Embodiments

The present invention is described by the Embodiments described above, but it should not be understood that the statement and the drawings forming part of this disclosure do not limit the present invention in any way. Various alternative embodiments, examples, and operation technologies will become apparent to those skilled in the art from this disclosure.

In the Embodiments, a handle 120 has a first portion 121 and a second portion 122. However, the Embodiments are not limited thereto. Specifically, the handle 120 only needs to have a guide groove 123 for supporting a grip 210 in such a manner that a cooking tool 200 passes through an upper side of an upper end 112X of a sidewall 112, in a place 113 in which the handle 120 is provided on an outer surface 112A of the sidewall 112 (body 110). Accordingly, a shape of the handle 120 is arbitrary.

1. A cookware, comprising:
a body that has a bottom plate and a sidewall raised upward from an outer periphery of the bottom plate; and
a handle provided on an outer surface of a side surface of the sidewall and positioned outside the body;
wherein the handle has a guide groove for supporting a rod-shaped grip of a cooking tool, on a top surface of the handle;
the guide groove supports the grip in such a manner that the cooking tool passes through an upper side of an upper end of the sidewall, in a place in which the handle is provided on the outer surface;
the handle has a shape extending obliquely upward from the outer surface of the sidewall; and
a width of the guide groove is reduced from a tip side of the handle toward a base side of the handle.

2. The cookware according to claim 1, wherein the guide groove has a predetermined shape in corresponding to the grip in a top view of the cookware.

3. The cookware according to claim 1, wherein the handle has a first portion in contact with the outer surface of the sidewall; and a second portion continuing to the first portion;
the first portion has a first angle as an inclination angle relative to a plane parallel to the bottom plate;
the second portion has a second angle smaller than the first angle as the inclination angle relative to the plane parallel to the bottom surface;
the guide groove is provided on a top surface of the second portion;
a virtual line obtained by virtually extending a groove bottom of the guide groove to a side of the body passes through an upper side of an upper end of the sidewall, in a place in which the handle is provided on the outer surface; and
a width of the guide groove is reduced from a tip side of the second portion toward a base side of the second portion.

4. The cookware according to claim 3, wherein a length of the guide groove is equal to or more than a half of a length of the second portion in a direction in which the second portion is extended.

5. The cookware according to claim 3, wherein a groove bottom of the guide groove in a boundary portion between the first portion and the second portion is positioned on an upper side above an upper end of the sidewall, in a place in which the handle is provided on the outer surface.

6. The cookware according to claim 1, wherein the handle has a magnet in a portion in which the guide groove is provided.

7. The cookware according to claim 1, wherein the handle has a holding part for holding an end part of the grip supported by the guide groove.

8. The cookware according to claim 7, wherein the holding part has an insertion port into which an end part of the grip is inserted in a state in which the grip is supported by the guide groove, and a regulation part positioned on an upper side of the end part of the grip inserted into the insertion port to regulate upward movement of the end part of the grip.

9. The cookware according to claim 7, wherein the holding part has a regulation part positioned on an upper side of a folded portion of an end part of the grip in a state in which the grip is supported by the guide groove to regulate upward movement of the folded portion.

10. A cookware set, comprising a cookware and a cooking tool having a rod-shaped grip, wherein
the cookware includes:
a body that has a bottom plate and a sidewall raised upward from an outer periphery of the bottom plate; and
a handle provided on an outer surface of a side surface of the sidewall and positioned outside the body;
the handle has a guide groove for supporting the grip, on a top surface of the handle;
the guide groove supports the grip in such a manner that the cooking tool passes through an upper side of an upper end of the sidewall, in a place in which the handle is provided on the outer surface;
the handle has a shape extending obliquely upward from the outer surface of the sidewall; and
a width of the guide groove is reduced from a tip side of the handle toward a base side of the handle.

11. The cookware set according to claim 10, wherein a width of the grip is reduced from a tip side of the grip toward a base side of the grip.

12. The cookware set according to claim 11, wherein the guide groove has a predetermined shape in corresponding to the grip in a top view of the cookware.

13. The cookware set according to claim 10, wherein
the handle has a first portion in contact with the outer surface of the sidewall; and a second portion continuing to the first portion;
the first portion has a first angle as an inclination angle relative to a plane parallel to the bottom plate;
the second portion has a second angle smaller than the first angle as the inclination angle relative to the plane parallel to the bottom surface;
the guide groove is provided on a top surface of the second portion;
a virtual line obtained by virtually extending a groove bottom of the guide groove to a side of the body passes through an upper side of an upper end of the sidewall, in a place in which the handle is provided on the outer surface; and
a width of the guide groove is reduced from a tip side of the second portion toward a base side of the second portion.

14. The cookware set according to claim 10, wherein
either the handle or the grip has a magnet, and
the other of the handle or the grip is formed of a magnetic body.

15. The cookware set according to claim 10, wherein
the handle has a first magnet,
the grip has a second magnet, and
the first magnet and the second magnet are provided in a position in which both are faced each other.

16. A cookware, comprising:
a body having a bottom plate and a sidewall raised upward from an outer periphery of the bottom plate; and
a handle provided on an outer surface of a side surface of the sidewall and positioned on an outer side of the body, wherein the handle has a guide groove for supporting a rod-shaped grip of a cooking tool, on a top surface of the handle, and
the guide groove supports the grip in such a manner that the cooking tool passes through an upper side of an upper end of the sidewall, in a place in which the handle is provided on the outer surface.

17. The cookware according to claim 16, wherein a virtual line obtained by virtually extending a groove bottom of the guide groove to a side of the body passes through an upper side of an upper end of the sidewall, in a place in which the handle is provided on the outer surface.

18. The cookware according to claim 16, wherein the handle has a shape extending obliquely upward from the outer surface of the sidewall; and
the handle has: a first portion in contact with the outer surface of the sidewall; and a second portion continuing to the first portion;
the first portion has a first angle as an inclination angle relative to a plane parallel to the bottom plate;
the second portion has a second angle smaller than the first angle as the inclination angle relative to the plane parallel to the bottom plate; and
the guide groove is provided on a top surface of the second portion.

19. The cookware according to claim 18, wherein a length of the guide groove is equal to or more than a half of a length of the second portion in a direction in which the second portion is extended.

20. The cookware according to claim 18, wherein a groove bottom of the guide groove in a boundary portion between the first portion and the second portion is positioned on an upper side above an upper end of the sidewall, in a place in which the handle is provided on the outer surface.

21. The cookware according to claim 16, wherein the handle has a magnet in a portion in which the guide groove is provided.

22. The cookware according to claim 16, wherein the handle has a holding part for holding an end part of the grip supported by the guide groove.

23. The cookware according to claim 22, wherein the holding part has: an insertion port into which an end part of the grip is inserted in a state in which the grip is supported by the guide groove; and a regulation part positioned on an upper side of the end part of the grip inserted into the insertion port to regulate upward movement of the end part of the grip.

24. The cookware according to claim 22, wherein the holding part has a regulation part positioned on an upper side of a folded portion of an end part of the grip in a state in which the handle is supported by the guide groove to regulate upward movement of the folded portion.

25. A cookware set, comprising a cookware and a cooking tool having a rod-shaped grip, wherein
the cookware includes:
a body that has a bottom plate and a sidewall raised upward from an outer periphery of the bottom plate; and
a handle provided on an outer surface of a side surface of the sidewall and positioned outside the body;
the handle has a guide groove for supporting the grip, on a top surface of the handle; and
the guide groove supports the grip in such a manner that the cooking tool passes through an upper side of an upper end of the sidewall, in a place in which the handle is provided on the outer surface.

26. The cookware set according to claim 25, wherein either the handle or the grip has a magnet and the other of the handle or the grip is formed of a magnetic body.

27. The cookware set according to claim 25, wherein
the handle has a first magnet,
the grip has a second magnet, and
the first magnet and the second magnet are provided in a position in which both are faced each other.
